(19) United States
(12) Patent Application Publication
(10) Pub. No.: US 2026/0366626 A1
(43) Pub. Date: Nov. 19, 2026

(54) APPARATUS FOR NOISE REDUCTION IN VALVES

(71) Applicant: Fisher Controls International LLC, Marshalltown, IA (US)

(72) Inventor: Yan Qiu, Marshalltown, IA (US)

(21) Appl. No.: 19/212,141

(22) Filed: May 19, 2025

(51) Int. Cl. F16K 5/06; F16K 3/26; F16K 47/04

(52) U.S. Cl. CPC F16K 5/0605; F16K 3/262; F16K 3/265; F16K 47/04

(57) ABSTRACT

Apparatus for noise reduction in valves are disclosed herein. An apparatus includes a base and a wall extending from the base. The wall includes a first passageway extending through the wall, where the first passageway has a first angle relative to a transverse axis of the apparatus. The wall includes a second passageway extending through the wall, where the second passageway is spaced from the first passageway along a longitudinal axis of the wall. The second passageway has a second angle relative to the transverse axis. The first angle is different than the second angle.

### FIELD OF THE DISCLOSURE

This disclosure relates generally to valves and, more particularly, to apparatus for noise reduction in valves.

### BACKGROUND

Valves are commonly used in process control systems to control the flow of process fluids (e.g., water, gas, etc.). Sliding stem valves (e.g., a gate valve, a globe valve, a diaphragm valve, a pinch valve, etc.) typically have a trim assembly disposed in a fluid passageway of the valve that may be used to reduce flow capacity, pressure drop, attenuate noise and/or reduce or eliminate cavitation.

### SUMMARY

An example apparatus includes a base and a wall extending from the base. The wall includes a first passageway extending through the wall, where the first passageway has a first angle relative to a transverse axis of the apparatus. The wall includes a second passageway extending through the wall, where the second passageway is spaced from the first passageway along a longitudinal axis of the wall. The second passageway has a second angle relative to the transverse axis. The first angle is different than the second angle.

An example valve plug includes a shoulder wall, and a side wall protruding from the shoulder wall. The side wall includes an outer surface and an inner surface. A portion of the side wall includes a plurality of passageways radially spaced and extending between the outer surface and the inner surface, where ones of the passageways are spaced along a longitudinal axis of the valve plug and extending at different angles relative to a transverse axis of the valve plug.

An example valve disclosed herein includes a valve body defining a fluid passageway between an inlet and an outlet, a cage in the fluid passageway, and a plug disposed in the cage. The plug includes a shoulder wall, and a side wall protruding from the shoulder wall. The side wall includes an outer surface, and an inner surface, a portion of the side wall including a plurality of passageways spaced apart along a length of the side wall. The passageways define lengths through the side wall between the outer surface and the inner surface, where the lengths of the passageways progressively increasing between adjacent ones of the passageways spaced apart along the length of the side wall.

### BRIEF DESCRIPTION OF THE DRAWINGS

FIG. 1 is a perspective view of an example fluid valve having an example valve plug in accordance with teachings of this disclosure.

FIG. 2 is a cross-sectional view of the example fluid valve of FIG. 1.

FIG. 3A is a front, cross-sectional view of a portion of the valve plug of FIGS. 1 and 2.

FIG. 3B is a front view of the example valve plug of FIG. 3A.

FIG. 4A is an enlarged, perspective, cross-sectional view of the example fluid valve of FIGS. 1 and 2 in an example open position.

FIG. 4B is an enlarged, perspective, cross-sectional view of the example fluid valve of FIGS. 1 and 2 in an example closed position.

FIG. 5 is a cross-sectional view of an example cage in accordance with teachings of this disclosure.

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Many known process control and/or fluid distribution systems (e.g., power generation systems, petroleum refinery systems, etc.) employ process control devices to affect the flow of fluid. For example, valves are a common type of process control device that are used to control the flow of fluid (e.g., liquids, gases, etc.) between an upstream source and a downstream location. Some known valves, such as sliding-stem valves (e.g., globe valves) include a plug that is moveable relative to a seat between an open position and a closed position. When the plug is in the opened position, the plug is disengaged from the seat and allows fluid to flow from an inlet of the valve to an outlet of the valve. When the plug is in the closed position, the plug is engaged with the seat and prevents fluid flow between the inlet and the outlet. Opening and closing of the valve can be performed manually or via a command signal that controls an actuator to move the plug.

A valve, often a control or throttling valve, has a narrow passage or orifice that restricts the flow of fluid through a fluid flow passageway of the valve. This restriction can cause a significant pressure drop across the valve. When the valve is in the open position, the restriction of the flow through the valve (e.g., through an orifice of a fluid flow passageway) increases the velocity of the fluid and decreases the pressure of the fluid. As the fluid (e.g., a vapor or gas) passes through the orifice, the sudden reduction in pressure can cause the fluid to expand rapidly. This pressure drop converts a potential energy (pressure) of the fluid into kinetic energy, accelerating the flow. With superheated fluids (e.g., steam or gas), if a pressure differential across the orifice is large enough, the fluid can reach sonic or supersonic velocities, forming a high-speed jet. The jetted flow occurs due to fluid accelerating to or exceeding the speed of sound (chocked flow) at a throat of a valve, and further expansion of the fluid downstream can increase the velocity of the fluid beyond Mach 1, creating a jet-like stream. In supersonic conditions, shock waves may form downstream as the jet interacts with a lower-pressure environment, which can cause turbulence, noise, and potential cavitation or erosion in the valve or downstream piping. For example, as high-velocity fluid exits the valve, the high-velocity fluid interacts with relatively stationary or low velocity fluid at an outlet of the valve. After exiting the valve, the high-velocity jet dissipates its kinetic energy into the downstream system, often through mixing with slower-moving fluid or by impacting pipe walls, which can cause vibrations and noise. The interaction of fluids occurs at a shear layer between the high-velocity fluid and the stationary or low velocity fluid. In such cases, noise is caused by an increase in turbulence at the shear layer.

In some examples, valves are equipped with a trim assembly to control the noise and/or cavitation of the fluid flowing through the valve. One way in which a trim assembly may control noise is pressure staging. Pressure staging keeps the pressure from falling to near the vapor pressure of the fluid, thereby helping to prevent high-velocity jet flow and/or vapor bubbles from forming. During pressure staging, the pressure drop across the valve is split using a multi-stage trim such as a valve plug and a cage. Some example multi-staging trim assemblies include a first stage pressure reduction valve plug upstream from a second stage pressure reducing cage. The valve plug and the cage include openings through which the fluid travels which result in jet separation or dissipation of the high-velocity fluid traveling through the valve.

In some examples, to achieve desirable noise abatement, the openings in the valve plug are relatively small, such as 1/16 ″ (inch) in diameter. Smaller diameter openings create noise composed of higher acoustic frequencies than larger diameter openings. Human hearing is in the range of 20-20,000 hertz (Hz). Therefore, using smaller diameter openings tends to shift the noise frequency to frequencies that are less audible or not audible at all to the human ear.

However, spacing the openings too closely along a longitudinal axis or length of a valve plug does not effectively disburse jet flow or high-speed jet. To the contrary, if the openings in the valve plug are spaced too closely, the high-velocity jet flow recombines as turbulent flow after passing through the openings and continues to flow downstream of the valve plug as a jet, generating noise and sonic and/or supersonic flow. One solution to disburse or eliminate high-velocity jet flow is to space the openings farther apart along the length and/or longitudinal axis of the valve plug. However, such a solution requires an increase in an overall length of the valve plug and, thus, the overall size or envelope of the valve plug and/or the fluid valve (i.e., a valve body). Thus, such solutions may not be feasible for use in process environments having space constraints.

Disclosed herein are example valve plugs for valves (e.g., globe valves, ball valves, etc.) and/or cages that include openings to disburse high-velocity jet flow. Specifically, for example, valve plugs disclosed herein provide a perforated flow down valve plug configuration with angled passageways (e.g., holes) or gradually increasing angled passageways or holes for noise or fluid jet separation to maintain noise frequency below desired levels. Example valve plugs disclosed herein enable trim fluid velocity control below or less than critical flow (choke) for each pressure reducing stage. The openings in the valve plug can be spaced apart without increasing an overall length of the valve plug. For example, a valve plug disclosed herein includes a plurality of passageways spaced apart along a longitudinal axis of the valve plug, where at least one of angles or lengths of the passageways progressively increase between adjacent ones of the passageways, which are spaced apart in a direction along the longitudinal axis of the valve plug. As a result, distances between adjacent ones of outlets of the passageways progressively increase along the longitudinal axis of the valve plug. In this manner, the jet flow is disbursed and cannot recombine within a flow passage of the valve plug and/or downstream from the valve plug. Thus, an overall length of the valve plug can be maintained with improved jet disbursement capabilities as a result of spacing outlets of the passageways at greater distances compared to valve plugs that have openings with central axes that are parallel to a transverse axis of the valve plug. The example valve plugs disclosed herein provide angled holes or gradually increasing angle holes without sacrificing valve travel, valve size and/or costs due to hole spacing to separate jet noise recombination. The openings of valve plugs disclosed herein can be sized based on the application needs to achieve the desired noise attenuation, cavitation reduction, flow capacity, and other parameters. In some examples, a cage and/or other valve trim components can be implemented with example openings disclosed herein.

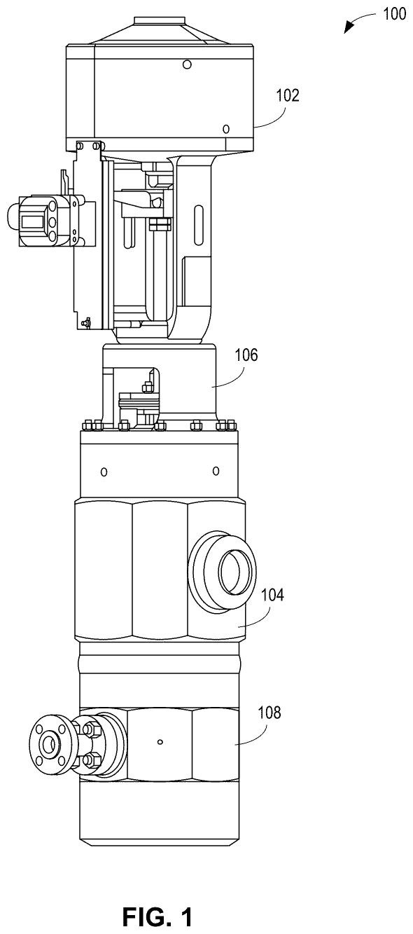

FIG. 1 is a perspective view of an example valve 100 constructed in accordance with teachings of this disclosure. The valve 100 of the illustrated example includes an actuator 102 (e.g., a pneumatic actuator, a hand-operated device (e.g., a handwheel), etc.) coupled to a valve body 104 via a bonnet 106. The valve 100 of the illustrated example includes a desuperheater nozzle 108 coupled to the valve body 104. The desuperheater nozzle 108 can be used to inject fluid (e.g., steam) within a process fluid flowing though the valve body 104. The valve body 104 can be used to control the flow of fluid between an upstream source and a downstream area, can be used as a bypass valve, and/or with another suitable process. The valve 100 can be used to control the flow of a fluid, such as water, vapor or gas. The valve 100 is a type of sliding stem valve, such as a globe valve. In other examples, the valve 100 can be implemented as another type of valve.

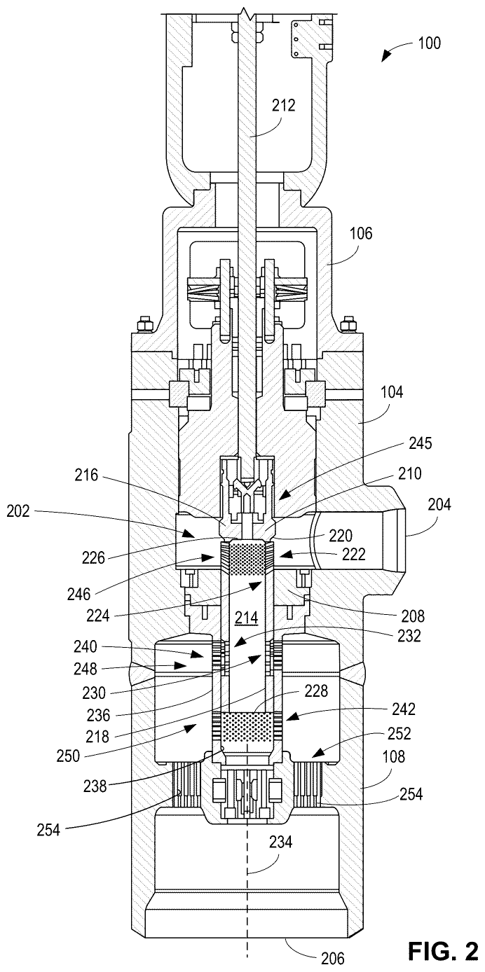

FIG. 2 is a cross-sectional view of the example valve 100 of FIG. 1. In the illustrated example, the valve body 104 defines a fluid passageway 202 between an inlet 204 and an outlet 206. In the illustrated example, the valve 100 is a flow-down fluid valve, where fluid flows downward from the inlet 204 to the outlet 206. In the illustrated example, the valve 100 includes an example valve seat 208 disposed in the fluid passageway 202. The valve 100 also includes an example valve plug 210 (e.g., a flow control member) in accordance with teachings of this disclosure. The valve 100 includes an example valve stem 212 that is coupled to the valve plug 210 and extends through the bonnet 106 to couple to the actuator 102 (FIG. 1). The actuator 102 moves the valve plug 210 in a rectilinear direction relative to the valve seat 208 to control fluid flow through the fluid passageway 202 between the inlet 204 and the outlet 206.

The valve plug 210 of the illustrated example has a cylindrical body. Specifically, the valve plug 210 of the illustrated example includes a central bore 214 (e.g., a central cavity). The central bore 214 defines a portion of the fluid passageway 202. The valve plug 210 of the illustrated example includes a shoulder or base 216 and a side wall 218 (e.g., a cylindrical body or wall) extending from the base 216. The base 216 defines a sealing surface 220 that sealingly engages the valve seat 208 when the valve 100 is in a closed position (e.g., to restrict or prevent fluid flow through the central bore 214). The side wall 218 of the valve plug 210 includes a plurality of first openings 222 positioned on a portion 224 of the valve plug 210 between a first end 226 of the side wall 218 and a second end 228 of the side wall 218. Additionally, the valve plug 210 includes a plurality of second openings 230 positioned on a second portion 232 of the side wall 218 of the valve plug 210. The first openings 222 and the second openings 230 are spaced apart along a longitudinal axis 234 of the valve plug 210.

In the illustrated example, the valve 100 includes an example cage 236 disposed in the fluid passageway 202. In this example, the cage 236 is cylindrical or sleeve-shaped. The cage 236 defines a central bore 238. The valve plug 210 is disposed in the central bore 238 of the cage 236. Specifically, the side wall 218 is slidably disposed in the central bore 238 of the cage 236. The valve plug 210 is moveable (e.g., slidable) in a rectilinear direction (e.g., an up and down direction in the orientation of FIG. 2) in the central bore 238 of the cage 236 to control fluid flow through the fluid passageway 202. In the illustrated example, the cage 236 is coupled to the valve body 104. In the illustrated example, the cage 236 is clamped between the desuperheater nozzle 108 and the valve seat 208. However, in some examples, the cage 236 can be coupled to the valve body 104 in other manners (e.g., the cage 236 can be clamped between two portions of the valve body 104, the cage 236 can be a hung cage, etc.). Additionally, the cage 236 has a plurality of first openings 240 spaced from a plurality of second openings 242 in a direction along the longitudinal axis 234 of the cage 236. The size, shape, and/or layout of the openings 240, 242, 244 can be designed to reduce noise and cavitation.

The valve plug 210 and the cage 236 of the illustrated example are part of a valve trim assembly 245. The valve trim assembly 245 of the illustrated example is a multi-stage, pressure reducing trim. Specifically, the valve trim assembly 245 of the illustrated example is a multi-stage trim assembly that reduces pressure in various stages across the fluid flow passageway to attenuate noise and/or cavitation in high-pressure and/or high velocity applications. To provide a multi-stage pressure and/or velocity reducing trim, the trim assembly 245 of the illustrated example includes a first pressure-reducing stage 246, second pressure-reducing stages 248 and 250, and a third pressure-reducing stage 252. The first pressure-reducing stage 246 is provided by the first openings 222 of the valve plug 210. The first openings 222 enable fluid flow from the inlet 204 to flow toward the outlet 206 through the central bore 214 of the side wall 218 of the valve plug 210. The second openings 230 of the valve plug 210 align with the first openings 240 of the cage 236 to provide the second pressure-reducing stage 248, and the second openings 242 of the cage 236 provide the second pressure-reducing stage 250. The third pressure-reducing stage 252 is provided by passageways 254 radially spaced within the desuperheater nozzle 108.

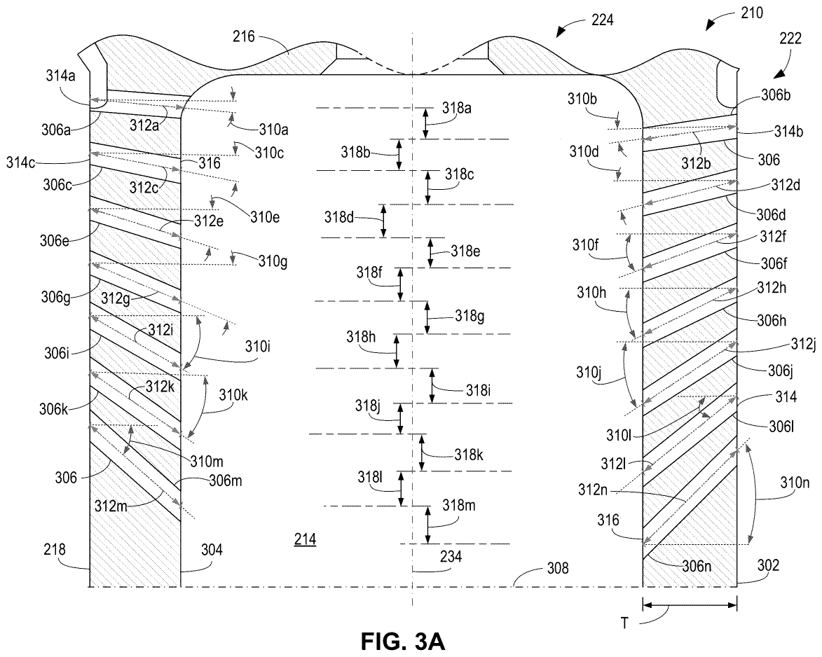

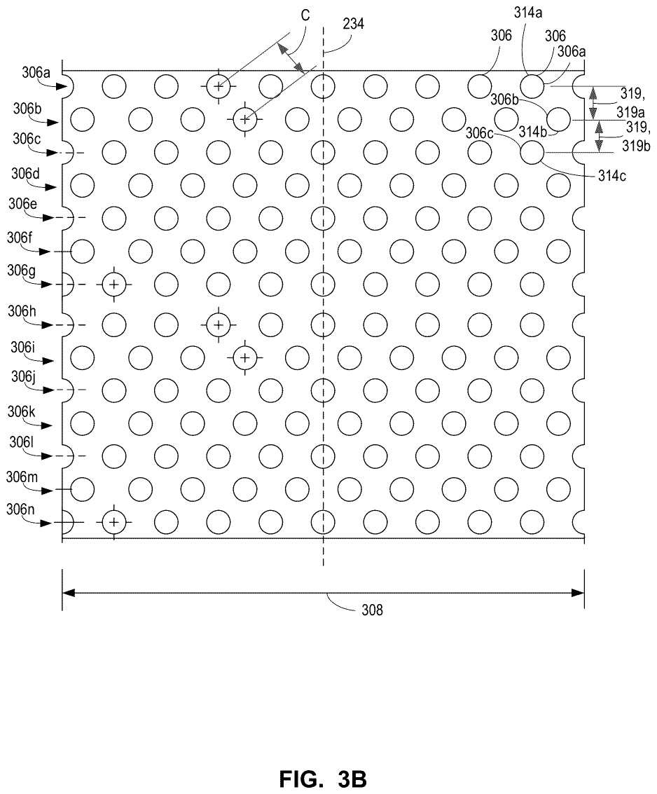

FIG. 3A is a partial, cross-sectional view of the valve plug 210 of FIG. 2. FIG. 3B is a partial, front view of the valve plug 210 of FIG. 2. Specifically, FIGS. 3A and 3B illustrate the portion 224 of the valve plug 210 having the first openings 222. The first openings 222 are located on the side wall 218 of the valve plug 210 adjacent the base 216. The side wall 218 of the valve plug 210 is a cylindrical body having an outer surface 302 and an inner surface 304. The inner surface 304 defines the central bore 214 of the side wall 218. The side wall 218 of the illustrated example has a thickness T (e.g., a uniform thickness) between the outer surface 302 and the inner surface 304 along a length of the side wall 218 between the first end 226 of the side wall 218 and the second end 228 of the side wall 218 opposite the first end 226. In some examples, the portion 224 of the side wall 218 has a uniform thickness. As such, other portions of the side wall 218 not including the portion 224 can have a variable thickness. In some examples, the side wall 218 (e.g., the portion 224) can have a varying thickness between the first end 226 and the second end 228. In some examples, the inner surface 304 of the side wall 218 can have a tapered, straight, non-uniform and/or varying profile between the first end 226 and the second end 228. For example, an inner diameter of the side wall 218 can be uniform or vary between the first end 226 and the second end 228 of the side wall 218.

The first openings 222 define fluid passageways 306 radially spaced relative to the longitudinal axis 234 and extend between the outer surface 302 and the inner surface 304. The passageways 306 of the illustrated example are arranged in rows or sets 306a-306n of the passageways 306 radially spaced about a circumference of the side wall 218. In the illustrated example, the sets 306a-306n of passageways 306 extend along a transverse axis 308 of the valve plug 210. Additionally, each of the sets 306a-306n of passageways 306 is spaced apart along the longitudinal axis 234 of the valve plug 210. In the illustrated example, the valve plug 210 includes fourteen sets 306a-306n (e.g., rows) of passageways 306 radially spaced about a circumference of the side wall 218. However, in other examples, the valve plug 210 can include any number or rows or sets of passageways 306. For example, the valve plug 210 can include three sets, four sets, six sets, twenty sets, etc.

The passageways 306 of respective ones of the sets 306a-306n extend at respective angles 310a-310n relative to the transverse axis 308 of the valve plug 210. Additionally, the passageways 306 of respective ones of the sets 306a-306n of the passageways 306 have lengths 312a-312n. Thus, each of the passageways 306 defines a length through the side wall 218 between the outer surface 302 and the inner surface 304. In the orientation of FIG. 3A, the angles 310a-310n and the lengths 312a-312n are oriented or sloped downwardly from the outer surface 302 toward the inner surface 304. The passageways 306 include inlets 314 formed on the outer surface 302 of the side wall 218 and outlets 316 formed on the inner surface 304 of the side wall 218. An inlet 314 of a respective one of the passageways 306 is offset relative to an outlet 316 in a direction along the longitudinal axis 234 of the valve plug 210. The inlets 314 are spaced apart and have distances C (FIG. 3B) (e.g., similar or equal distances) between the centers of respective adjacent ones of the passageways 306.

For example, the first set 306a of passageways 306 includes a first angle 310a and a first length 312a, the second set 306b of passageways 306 includes a second angle 310b and a second length 312b, the third set 306a of passageways 306 includes a third angle 310c and a third length 312c, the fourth set 306a of passageways 306 includes a fourth angle 312d and a fourth length 314d, the fifth set 306e of passageways 306 includes a fifth angle 310e and a fifth length 312e, etc.

The angles 310a-310n of the passageways 306 progressively increase in a direction along the longitudinal axis 234 of the valve plug 210 (from the base 216 toward the second end 228 of the valve plug 210). Additionally, the lengths 312a-312n of the passageways 306 progressively increase between adjacent ones of the passageways 306 spaced apart along the length of the side wall 218. As such, the lengths 312a-312n of the passageways 306 spaced along the longitudinal axis 234 progressively increase between a first end 226 of the portion 224 of the side wall 218 and a second end 228 of the portion 224 of the side wall 218 opposite the first end 226. As a result, the outlets 316 of respective ones of the sets 306a-306n of the passageways 306 are spaced apart at different lengths along the longitudinal axis 234. Specifically, the distances 318a-318m between the outlets 316 of respective ones of the sets 306a-306n of passageways 306 progressively increase along the longitudinal axis 234 in a direction from the base 216 toward the second end 228 of the valve plug 210.

For example, the outlets 316 of the first set 306a of the passageways 306 are spaced apart from the outlets 316 of the second set 306b of passageways 306 by a first length 318a (e.g., a first distance) along the longitudinal axis 234, the second set 306b of passageways 306 is spaced apart from the third set 306c of passageways 306 by a second length 318b (e.g., a second distance), where the second length 318b is greater than the first length 318a. In the illustrated example, the outlets 316 of the third set 306c of passageways 306 are spaced apart from the outlets 316 of the fourth set 306d of passageways 306 by a third length 318c, the third length 318c being greater than the second length 318b. In the illustrated example, the outlets 316 of the fifth set 306e of passageways 306 are spaced apart from the outlets 316 of the fourth set 306d of passageways 306 by a fourth length 318d, where the fourth length 318d is greater than the third length 318c, etc.

For example, a first outlet 316a of a first passageway 320a of the first set 306a of passageways 306 is spaced from a second outlet 316b of a second passageway 320b of the second set 306b of the passageways 306 adjacent the first passageway 320a by the first length 318a along the longitudinal axis 234 of the valve plug 210. The second outlet 316b of a second passageway 320b of the second set 306b of passageways 306 is spaced from a third outlet 316c of a third passageway 320c of the third set 306c of passageways 306 by a second length 318b, etc.

In the illustrated example, the inlets 314 of respective ones of the sets 306a-306n (e.g., the first set 306a) of the passageways 306 are spaced relative to the inlets 314 of adjacent ones of the sets 306a-306n (e.g., the second set 306b) of the passageways 306 by a first distance 319. For example, a first inlet 314a from the first set 306a of the passageways 306 is spaced from a second inlet 314b of the second set 306b of the passageways 306 by a first distance 319a, a third inlet 314c from the third set 306c of the passageways 306 is spaced from the second inlet 314b of the second set 306b of the passageways 306 by a second distance 319b, etc. The distance 319a is equal to the second distance 319b. However, in some examples, the distances 319a and 319b can be different.

In the illustrated example, the angles 310a-n of the passageways 306 progressively increase between adjacent ones of the sets 306a-306n of the passageways 306. Thus, each passageway 306 from one of the sets 306a-306n (e.g., the first set 306a) is different from each passageway 306 from another one of the sets 306a-306n (e.g., the second set 306b). In the illustrated example, no two passageways 306 that are spaced apart along the longitudinal axis 234 have the same angle 310a-n relative to the transverse axis 308. Alternatively or additionally, no two passageways 306 that are spaced apart along the longitudinal axis 234 have the same length. In the illustrated example, each passageway 306 from one of the sets or rows (e.g., a first row 306a) is the same or identical in dimension, shape and/or orientation. However, in some examples, each passageway 306 from one of the sets or rows (e.g., the first row 306a) can be different in shape, dimension and/or orientation. In some examples, the passageways 306 of the illustrated example can have diameters of between approximately 0.0625 inches (0.1588 centimeters) or 0.125 inches (0.3175 centimeters).

In some examples, the first angle 310a can be approximately between 4 degrees and 5 degrees. In some examples, the second angle 310b can be approximately between 6 degrees and 9 degrees. In some examples, the third angle 310c can be approximately between 10 degrees and 12 degrees. In some examples, the fourth angle 310d can be approximately between 13 degrees and 15 degrees. In some examples, the fifth angle 310e can be approximately between 16 degrees and 18 degrees. In some examples, the sixth angle 310f can be approximately between 20 degrees and 22 degrees. In some examples, the seventh angle 310g can be approximately between 22 degrees and 24 degrees. In some examples, the eighth angle 310h can be approximately between 25 degrees and 28 degrees. In some examples, the ninth angle 310i can be approximately between 28 degrees and 30 degrees. In some examples, the tenth angle 310j can be approximately between 31 degrees and 34 degrees. In some examples, the eleventh angle 310k can be approximately between 34 degrees and 38 degrees. In some examples, the twelfth angle 310L can be approximately between 37 degrees and 40 degrees. In some examples, the thirteenth angle 310m can be approximately between 41 degrees and 43 degrees. In some examples, the fourteenth angle 310n can be approximately between 40 degrees and 43 degrees.

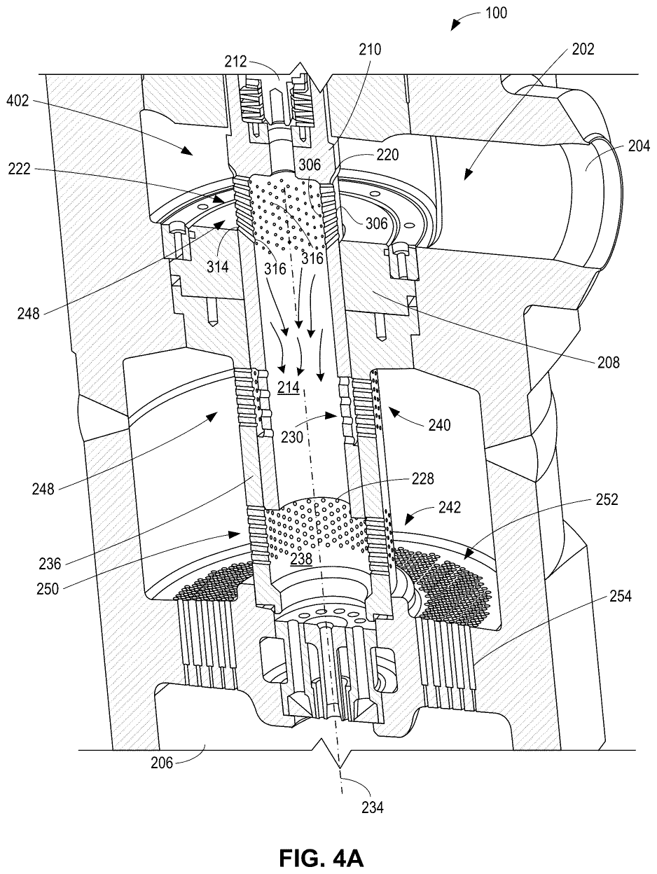

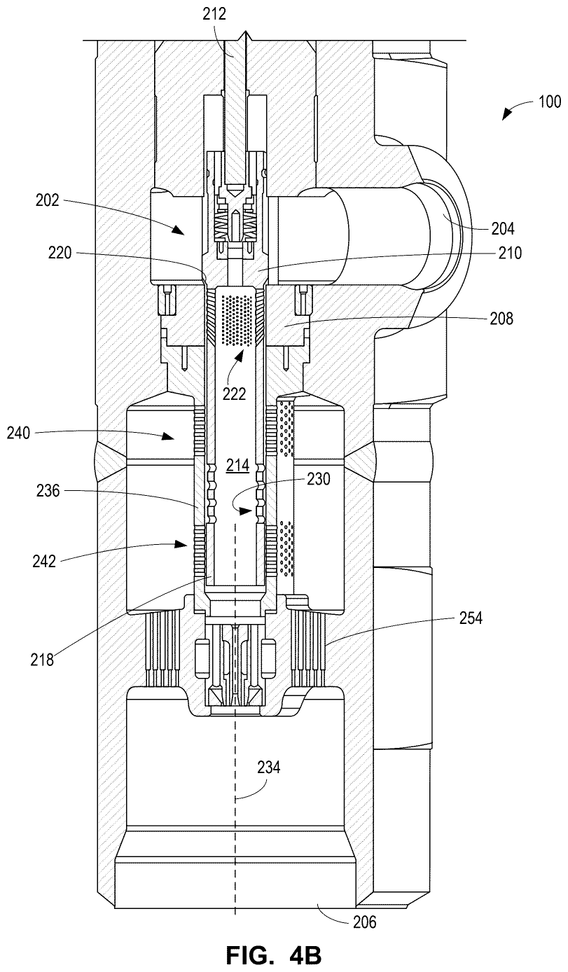

FIG. 4A is a perspective cross-sectional view of the example valve 100 in an example first or open position 402. FIG. 4B is a perspective cross-sectional view of the example valve 100 in an example second or closed position 404. Referring to FIGS. 4A and 4B, in operation, the actuator 102 (FIG. 1) moves the valve stem 212 in a rectilinear direction (e.g., up and down in the orientation of FIGS. 4A and 4B) to move the valve plug 210 between the open position 402 and the closed position 404 relative to the valve seat 208. Specifically, the valve plug 210 moves relative to the valve seat 208 between the closed position 404 to prevent or restrict fluid flow though the fluid passageway 202 and the open position 402 to allow fluid flow through the fluid passageway 202.

In the closed position 404 of FIG. 4B, the sealing surface 220 of the valve plug 210 sealingly engages the valve seat 208 to prevent (e.g. block) fluid flow through the fluid passageway 202 (e.g., blocks the flow of fluid into the central bore 214 of the valve plug 210). In the closed position, the first openings 222 of the valve plug 210 are positioned within the central bore 238 of the cage 236 that is downstream from the valve seat 208, thereby preventing fluid flow through the fluid passageway 202.

In the open position 402, the valve plug 210 is spaced from the valve seat 208 to allow fluid flow through the fluid passageway 202 between the inlet 204 and the outlet 206. Specifically, the first openings 222 are in communication with the inlet 204, and the second openings 230 of the valve plug 210 are aligned (e.g., axially aligned) or in fluid communication with the first openings 240 of the cage 236. Additionally, the second end 228 of the valve plug 210 is spaced away from the second openings 242 of the cage 236 to uncover or expose the second openings 242 of the cage 236. In operation, fluid flows from the inlet 204 through the first openings 222 of the valve plug 210, through the central bore 214, through the second openings 230 of the valve plug 210 and the first openings 240 of the cage 236, through the second openings 242 of the cage 236, through the passageways 252 radially spaced within the desuperheater nozzle 108, and to the outlet 206.

Specifically, the fluid at the inlet 204 can be, in some examples, superheated and/or high pressure, high velocity fluid. The first openings 222 of the valve plug 210 distribute or spread the fluid flow from the inlet 204 into the central bore 214 to prevent the fluid at the inlet 204 from forming a jet through the central bore 214. Specifically, the first openings 222 disburse the high-velocity jet flow of the fluid at the inlet 204. Particularly, the first openings 222 of the valve plug 210 provide a perforated flow down valve plug configuration with angled passageways 306 (e.g., holes) (e.g., gradually increasing angle holes) for noise or fluid jet flow separation to maintain noise frequency below desired levels. The first openings 222 of the valve plug 210 of the illustrated example enables trim fluid velocity control below or less than critical flow (choke) for each of the pressure reducing stages 246, 248, 250, 252. The first openings 222 in the valve plug 210 can be spaced apart without increasing an overall length of a valve plug 210 and/or an overall length of the portion 224 of the valve plug 210 that includes the first openings 222. For example, the passageways 306 associated with the first openings 222 are spaced apart along the longitudinal axis 234 of the valve plug 210 and at least one of the angles 310a-310n (FIG. 3A) or the lengths 312a-312n (FIG. 3A) of the passageways 306 progressively increase between adjacent ones of the passageways 306 spaced apart in the direction along the longitudinal axis 234 of the valve plug 210. As a result, the distances 318a-318n (FIG. 3A) between adjacent ones of outlets 316 of the passageways 306 progressively increase along the longitudinal axis 234 of the valve plug 210. In this manner, jet flow is disbursed and cannot recombine within the flow passage (e.g., the central bore 214) of the valve plug 210 and flow downstream from the valve plug 210 as a jet. In other words, because the outlets 316 of the respective sets 306a-306n of the passageways 306 are spaced at progressively increasing distances along the longitudinal axis 234, the fluid flowing from the inlet 204 and through the first openings 222 is spaced or separated at larger or progressively increasing distances to reduce turbulent flow and/or instances of the fluid recombining into a jet. In contrast, if a distance between the outlets 316 of respective ones of the sets 306a-306n did not progressively increase, the fluid at the inlet 204 could flow to the central bore 214 as turbulent flow, which can recombine or develop into jet flow in the central bore 214. Additionally, by progressively increasing the distances 318a-318m (FIG. 3A), an overall length of the valve plug 210 can be maintained with improved jet disbursement capabilities as a result of spacing the outlets 316 of the passageways 306 at greater distances compared to valve plugs that have openings with central axes that are parallel to the transverse axis 308 of the valve plug 210. The valve plug 210 of the illustrated example provides angled passageways 306 without sacrificing valve travel, valve size, valve length and/or costs due to hole spacing to separate jet noise recombination. The first openings 222 of valve plug 210 disclosed herein can be sized based on the application needs to achieve the desired noise attenuation, cavitation reduction, flow capacity, and other parameters.

The example provided herein are not limited to the first pressure reducing stage 246. In other words, the passageways 306 are not limited to the valve plug 210 and/or the portion 224 of the valve plug 210. For example, the valve plug 210 can be formed with the passageways 306 instead of the openings 230 (e.g., the passageways 222 can implement the second pressure-reducing stage 248). Additionally, the passageways 306 disclosed herein can be provided with the cage 236 and/or any other structure of the trim assembly 245 and/or the fluid valve 100. For example, the cage 236 can include the passageways 306 in addition to, or instead of, the openings 240 (e.g., the passageways 306 can implement the second pressure-reducing stage 250). In some examples, the cage 236 can include the passageways 306 in addition to, or instead of, the openings 242 (e.g., implement the second pressure-reducing stage 250). In some examples, the desuperheater 108 can include the passageways 306 in addition to, or instead of, the openings 254 (e.g., the passageways 306 can implement the third pressure-reducing stage 252). In some examples, one or more of the openings 230, 240, 242 can include the passageways 306. In some examples, all of the openings 222, 232, 240, 242, 254 can include the passageways 306.

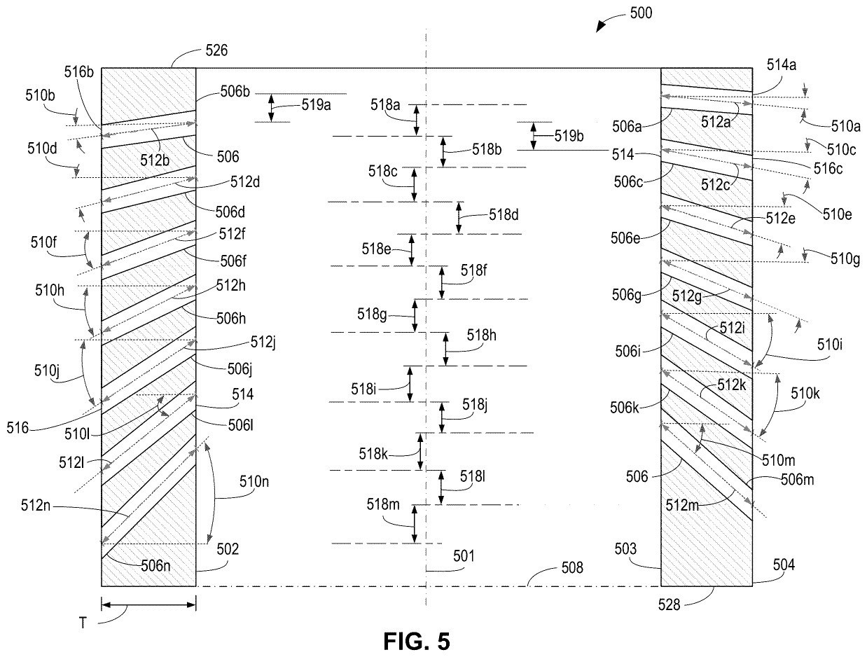

FIG. 5 is a cross-sectional, partial view of an example cage 500 disclosed herein having example passageways 506 in accordance with teachings of this disclosure. Many components of the example cage 500 of FIG. 5 are substantially similar or identical to the components described above in connection with FIGS. 1, 2, 3A, 3B, 4A and 4B. As such, those components will not be described in detail again below. Instead, the interested reader is referred to the above corresponding descriptions for a complete written description of the structure and operation of such components. To facilitate this process, similar or identical reference numbers will be used for like structures in FIG. 5 as used in FIGS. 1, 2, 3A, 3B, 4A, 4B. The cage 500 of FIG. 5 includes a cylindrical wall 503 including a plurality of passageways 506.

The plurality of fluid passageways 506 are radially spaced relative to the longitudinal axis 501 and extend between an inner surface 502 and an outer surface 504 defined by the wall 503. The passageways 506 of the illustrated example are arranged in rows or sets 506a-506n of the passageways 506 radially spaced about a circumference of the side wall 500. In the illustrated example, the sets 506a-506n of passageways 506 extend along a transverse axis 508 of the cage 500. Additionally, each of the sets 506a-506n of passageways 506 is spaced apart along the longitudinal axis 501 of the cage 500. In the illustrated example, the cage 500 includes fourteen sets 506a-506n (e.g., rows) of passageways 506 radially spaced about a circumference of the cage 500. However, in other examples, the cage 500 can include any number or rows or sets of passageways 506. For example, the cage 500 can include three sets, four sets, six sets, twenty sets, etc.

The passageways 506 of respective ones of the sets 506a-506n extend at respective angles 510a-510n relative to the transverse axis 508 of the cage 500. Additionally, the passageways 506 of respective ones of the sets 506a-506n of the passageways 506 have lengths 512a-512n. Thus, each of the passageways 506 defines a length through the wall 503 between the inner surface 502 and the outer surface 504. In the orientation of FIG. 5, the angles 510a-510n and the lengths 512a-512n are oriented or sloped downwardly from the inner surface 502 toward the outer surface 504. The passageways 506 include inlets 514 formed on the inner surface 502 of the wall 503 and outlets 516 formed on the outer surface 504 of the side wall 500. An inlet 514 of a respective one of the passageways 506 is offset relative to an outlet 516 in a direction along the longitudinal axis 501 of the cage 500. The inlets 514 are spaced apart and have distances (see distance C of FIG. 3B) (e.g., similar or equal distances) between centers of respective adjacent ones of the passageways 506.

For example, the first set 506a of passageways 506 includes a first angle 510a and a first length 512a, the second set 506b of passageways 506 includes a second angle 510b and a second length 512b, the third set 506a of passageways 506 includes a third angle 510c and a third length 512c, the fourth set 506a of passageways 506 includes a fourth angle 512d and a fourth length 514d, the fifth set 506e of passageways 506 includes a fifth angle 510e and a fifth length 512e, etc.

The angles 510a-510n of the passageways 506 progressively increase in a direction along the longitudinal axis 501 of the cage 500 (from a first end 526 toward a second end 528 of the cage 500). Additionally, the lengths 512a-512n of the passageways 506 progressively increase between adjacent ones of the passageways 506 spaced apart along the length of the wall 503. As such, the lengths 512a-512n of the passageways 506 spaced along the longitudinal axis 501 progressively increase between the first end 526 of the wall 503 and the second end 528 of the wall 503 opposite the first end 526. As a result, the outlets 516 of respective ones of the sets 506a-506n of the passageways 506 are spaced apart at different lengths along the longitudinal axis 501. Specifically, the distances 518a-518m between the outlets 516 of respective ones of the sets 506a-506n of passageways 506 progressively increase along the longitudinal axis 501 in a direction from the from the first end 526 toward the second end 528 of the cage 500.

For example, the outlets 516 of the first set 506a of the passageways 506 are spaced apart from the outlets 516 of the second set 506b of passageways 506 by a first length 518a (e.g., a first distance) along the longitudinal axis 501, the second set 506b of passageways 506 is spaced apart from the third set 506c of passageways 506 by a second length 518b (e.g., a second distance), where the second length 518b is greater than the first length 518a. In the illustrated example, the outlets 516 of the third set 506c of passageways 506 are spaced apart from the outlets 516 of the fourth set 506d of passageways 506 by a third length 518c, the third length 518c being greater than the second length 518b. In the illustrated example, the outlets 516 of the fifth set 506e of passageways 506 are spaced apart from the outlets 516 of the fourth set 506d of passageways 506 by a fourth length 518d, where the fourth length 518d is greater than the third length 518c, etc.

For example, a first outlet 516a of a first passageway 520a of the first set 506a of passageways 506 is spaced from a second outlet 516b of a second passageway 520b of the second set 506b of the passageways 506 adjacent the first passageway 520a by the first length 518a along the longitudinal axis 501 of the cage 500. The second outlet 516b of a second passageway 520b of the second set 506b of passageways 506 is spaced from a third outlet 516c of a third passageway 520c of the third set 506c of passageways 506 by a second length 518b, etc.

In the illustrated example, the inlets 514 of respective ones of the sets 506a-506n (e.g., the first set 506a) of the passageways 506 are spaced relative to the inlets 514 of adjacent ones of the sets 506a-506n (e.g., the second set 506b) of the passageways 506 by a distance 519a, 519b, etc. For example, a first inlet 514a from the first set 506a of the passageways 506 is spaced from a second inlet 514b of the second set 506b of the passageways 506 by a first distance 519a, a third inlet 514c from the third set 506c of the passageways 506 is spaced from the second inlet 514b of the second set 506b of the passageways 506 by a second distance 519b, etc. The first distance 519a is equal to the second distance 519b. However, in some examples, the distances 519a and 519b can be different.

In the illustrated example, the angles 510a-n of the passageways 506 progressively increase between adjacent ones of the sets 506a-506n of the passageways 506. Thus, each passageway 506 from one of the sets 506a-506n (e.g., the first set 506a) is different from each passageway 506 from another one of the sets 506a-506n (e.g., the second set 506b). In the illustrated example, no two passageways 506 that are spaced apart along the longitudinal axis 234 have the same angle 510a-n relative to the transverse axis 508. Alternatively or additionally, no two passageways 506 that are spaced apart along the longitudinal axis 501 have the same length. In the illustrated example, each passageway 506 from one of the sets or rows (e.g., a first row 506a) is the same or identical in dimension, shape and/or orientation. However, in some examples, each passageway 506 from one of the sets or rows (e.g., the first row 506a) can be different in shape, dimension and/or orientation. In some examples, the passageways 506 of the illustrated example can have diameters of between approximately 0.0625 inches (0.1588 centimeters) or 0.125 inches (0.5175 centimeters).

In some examples, the first angle 510a can be approximately between 4 degrees and 5 degrees. In some examples, the second angle 510b can be approximately between 6 degrees and 9 degrees. In some examples, the third angle 510c can be approximately between 10 degrees and 12 degrees. In some examples, the fourth angle 510d can be approximately between 13 degrees and 15 degrees. In some examples, the fifth angle 510e can be approximately between 16 degrees and 18 degrees. In some examples, the sixth angle 510f can be approximately between 20 degrees and 22 degrees. In some examples, the seventh angle 510g can be approximately between 22 degrees and 24 degrees. In some examples, the eighth angle 510h can be approximately between 25 degrees and 28 degrees. In some examples, the ninth angle 510i can be approximately between 28 degrees and 50 degrees. In some examples, the tenth angle 510j can be approximately between 51 degrees and 54 degrees. In some examples, the eleventh angle 510k can be approximately between 54 degrees and 58 degrees. In some examples, the twelfth angle 510L can be approximately between 57 degrees and 40 degrees. In some examples, the thirteenth angle 510m can be approximately between 41 degrees and 43 degrees. In some examples, the fourteenth angle 510n can be approximately between 40 degrees and 43 degrees.

In some examples disclosed herein, the valve plug 210, the first openings 222 of the valve plug 210, and/or the portion 224 of the valve plug 210 can be constructed via machining, drilling, an additive manufacturing process, sometimes referred to as three-dimensional (3D) printing and/or any other manufacturing process(es). As used herein, additive manufacturing or 3D printing refers to a manufacturing process that builds a 3D object by adding successive adjacent layers of material. The layers fuse together (e.g., naturally or via a subsequent fusing process) to form the 3D object. The material may be any material, such as plastic, metal, concrete, etc. Examples of additive manufacturing include Stereolithography (SLA), Selective Laser Sintering (SLS), fused deposition modeling (FDM), and multi-jet modeling (MJM). 3D printing is advantageous because it results in less wasted material than known machining operations.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

From the foregoing, it will be appreciated that example systems, apparatus, articles of manufacture, and methods have been disclosed that provide noise attenuation in fluid flow devices. Examples disclosed herein provide inserts that can be constructed to achieve desirable noise attenuation and cavitation reduction.

Examples and combinations of examples disclosed herein include the following:

Example methods, apparatus, systems, and articles of manufacture to noise attenuation apparatus are disclosed herein. Further examples and combinations thereof include the following:

Example 1 includes an apparatus comprising a base, and a wall extending from the base, the wall including a first passageway extending through the wall, the first passageway having a first angle relative to a transverse axis of the apparatus, and a second passageway extending through the wall, the second passageway spaced from the first passageway along a longitudinal axis of the wall, the second passageway having a second angle relative to transverse axis, the first angle being different than the second angle.

Example 2 includes the apparatus of example 1, wherein the valve plug includes a third passageway extending through the wall, the third passageway spaced from the first passageway and the second passageway along the longitudinal axis, the third passageway having a third angle relative to the transverse axis, the third angle different than the first angle and the second angle.

Example 3 includes the apparatus of any one of examples 1-2, wherein the first angle is approximately between 4 degrees and 5 degrees.

Example 4 includes the apparatus of any one of examples 1-3, wherein the second angle is approximately between 5 degrees and 7 degrees, and wherein the third angle is approximately between 10 degrees and 12 degrees.

Example 5 includes the apparatus of any one of examples 1-4, wherein the apparatus is at least one of a valve plug or a cage.

Example 6 includes the apparatus of examples 1-5, wherein the wall has a uniform thickness.

Example 7 includes a valve plug comprising a shoulder wall, and a side wall protruding from the shoulder wall, the side wall including an outer surface, and an inner surface, a portion of the side wall including a plurality of passageways radially spaced and extending between the outer surface and the inner surface, ones of the passageways spaced along a longitudinal axis of the valve plug and extending at different angles relative to a transverse axis of the valve plug.

Example 8 includes the valve plug of any one of example 7, wherein the portion of the side wall has a uniform thickness between a first end of the side wall and a second end of the side wall opposite the first end.

Example 9 includes the valve plug of any one of examples 7-8, wherein the angles of the passageways progressively increase in a direction along the longitudinal axis of the valve plug.

Example 10 includes the valve plug of any one of examples 7-9, wherein a respective one of the passageways includes an inlet on the outer surface of the side wall and an outlet on the inner surface of the side wall, the inlet offset relative to the outlet in a direction along the longitudinal axis of the valve plug.

Example 11 includes the valve plug of any one of examples 7-10, wherein the passageways include inlets formed on the outer surface of the side wall and inlets formed on the inner surface of the side wall, a first outlet of a first one of the passageways is spaced from a second outlet of a second one of the passageways adjacent the first one of the passageways by a first distance along the longitudinal axis of the valve plug, and wherein the second outlet of the second one of the passageways is spaced from a third outlet of a third one of the passageways adjacent the second one of the passageways by a second distance along the longitudinal axis of the valve plug, wherein the first distance is different than the second distance.

Example 12 includes the valve plug of any one of examples 7-11, wherein each of the passageways has a length between the outer surface and the inner surface, wherein the lengths of the passageways spaced along the longitudinal axis progressively increase between a first end of the portion of the side wall and a second end of the portion of the side wall opposite the first end.

Example 13 includes the valve plug of any one of examples 7-12, wherein no two passageways spaced apart along the longitudinal axis have the same angle relative to the transverse axis.

Example 14 includes the valve plug of any one of examples 7-13, wherein no two passageways spaced apart along the longitudinal axis have the same length.

Example 15 includes a valve comprising a valve body defining a fluid passageway between an inlet and an outlet, a cage in the fluid passageway, and a plug disposed in the cage, the plug including a shoulder wall, and a side wall protruding from the shoulder wall, the side wall including an outer surface, and an inner surface, a portion of the side wall including a plurality of passageways spaced apart along a length of the side wall, the passageways defining lengths through the side wall between the outer surface and the inner surface, the lengths of the passageways progressively increasing between adjacent ones of the passageways spaced apart along the length of the side wall.

Example 16 includes the valve of any one of example 15, wherein the portion of the side wall including the passageways has a uniform thickness.

Example 17 includes the valve of any one of examples 15-16, wherein the passageways include a first set of passageways radially spaced about a circumference of the side wall, the first set of passageways having a first length, and the passageways include a second set of passageways radially spaced about the circumference of the side wall, the second set of passageways having a second length, the first set of passageways spaced apart from the second set of passageways along the length of the side wall, the second length greater than the first length.

Example 18 includes the valve of any one of examples 15-17, wherein the valve plug includes a third set of passageways radially spaced about the circumference of the side wall, the third set of passageways having a third length, the third set of passageways spaced apart from the second set of passageways such that the second set of passageways is positioned between the first set of passageways and the third set of passageways, the third length being greater than the first length of the first set of passageways and the second length of the second set of passageways.

Example 19 includes the valve of any one of examples 15-18, wherein the plug includes a fourth set of passageways radially spaced about the circumference of the side wall, the fourth set of passageways having a fourth length, the fourth set of passageways spaced apart from the third set of passageways such that the third set of passageways is positioned between the second set of passageways and the fourth set of passageways, the fourth length being greater than the first length of the first set of passageways, the second length of the second set of passageways, and the third length of the third set of passageways.

Example 20 includes the valve of any one of examples 15-19, wherein each of the passageways defines an angle relative to a transverse axis of the plug, wherein the angles of the passageways progressively increase between adjacent ones of the passageways.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
a base; and
a wall extending from the base, the wall including:
a first passageway extending through the wall, the first passageway having a first angle relative to a transverse axis of the valve plug; and
a second passageway extending through the wall, the second passageway spaced from the first passageway along a longitudinal axis of the wall, the second passageway having a second angle relative to transverse axis, the first angle being different than the second angle.

2. The apparatus of claim 1, wherein the apparatus includes a third passageway extending through the wall, the third passageway spaced from the first passageway and the second passageway along the longitudinal axis, the third passageway having a third angle relative to the transverse axis, the third angle different than the first angle and the second angle.

3. The apparatus of claim 2, wherein the first angle is approximately between 4 degrees and 5 degrees.

4. The apparatus of claim 3, wherein the second angle is approximately between 5 degrees and 7 degrees, and wherein the third angle is approximately between 10 degrees and 12 degrees.

5. The apparatus of claim 4, wherein the apparatus is at least one of a valve plug or a cage.

6. The apparatus of claim 1, wherein the wall has a uniform thickness.

7. A valve plug comprising:
a shoulder wall; and
a side wall protruding from the shoulder wall, the side wall including:
an outer surface; and
an inner surface;
a portion of the side wall including a plurality of passageways radially spaced and extending between the outer surface and the inner surface, ones of the passageways spaced along a longitudinal axis of the valve plug and extending at different angles relative to a transverse axis of the valve plug.

8. The valve plug of claim 7, wherein the portion of the side wall has a uniform thickness between a first end of the side wall and a second end of the side wall opposite the first end.

9. The valve plug of claim 7, wherein the angles of the passageways progressively increase in a direction along the longitudinal axis of the valve plug.

10. The valve plug of claim 7, wherein a respective one of the passageways includes an inlet on the outer surface of the side wall and an outlet on the inner surface of the side wall, the inlet offset relative to the outlet in a direction along the longitudinal axis of the valve plug.

11. The valve plug of claim 7, wherein the passageways include inlets formed on the outer surface of the side wall and inlets formed on the inner surface of the side wall, a first outlet of a first one of the passageways is spaced from a second outlet of a second one of the passageways adjacent the first one of the passageways by a first distance along the longitudinal axis of the valve plug, and wherein the second outlet of the second one of the passageways is spaced from a third outlet of a third one of the passageways adjacent the second one of the passageways by a second distance along the longitudinal axis of the valve plug, wherein the first distance is different than the second distance.

12. The valve plug of claim 7, wherein each of the passageways has a length between the outer surface and the inner surface, wherein the lengths of the passageways spaced along the longitudinal axis progressively increase between a first end of the portion of the side wall and a second end of the portion of the side wall opposite the first end.

13. The valve plug of claim 7, wherein no two passageways spaced apart along the longitudinal axis have the same angle relative to the transverse axis.

14. The valve plug of claim 7, wherein no two passageways spaced apart along the longitudinal axis have the same length.

15. A valve comprising:
a valve body defining a fluid passageway between an inlet and an outlet;
a cage in the fluid passageway; and
a plug disposed in the cage, the plug including:
a shoulder wall; and
a side wall protruding from the shoulder wall, the side wall including:
an outer surface; and
an inner surface;
a portion of the side wall including a plurality of passageways spaced apart along a length of the side wall, the passageways defining lengths through the side wall between the outer surface and the inner surface, the lengths of the passageways progressively increasing between adjacent ones of the passageways spaced apart along the length of the side wall.

16. The valve of claim 15, wherein the portion of the side wall including the passageways has a thickness.

17. The valve of claim 15, wherein the passageways include a first set of passageways radially spaced about a circumference of the side wall, the first set of passageways having a first length, and the passageways include a second set of passageways radially spaced about the circumference of the side wall, the second set of passageways having a second length, the first set of passageways spaced apart from the second set of passageways along the length of the side wall, the second length greater than the first length.

18. The valve of claim 17, wherein the valve plug includes a third set of passageways radially spaced about the circumference of the side wall, the third set of passageways having a third length, the third set of passageways spaced apart from the second set of passageways such that the second set of passageways is positioned between the first set of passageways and the third set of passageways, the third length being greater than the first length of the first set of passageways and the second length of the second set of passageways.

19. The valve of claim 18, wherein the plug includes a fourth set of passageways radially spaced about the circumference of the side wall, the fourth set of passageways having a fourth length, the fourth set of passageways spaced apart from the third set of passageways such that the third set of passageways is positioned between the second set of passageways and the fourth set of passageways, the fourth length being greater than the first length of the first set of passageways, the second length of the second set of passageways, and the third length of the third set of passageways.

20. The valve of claim 15, wherein each of the passageways defines an angle relative to a transverse axis of the plug, wherein the angles of the passageways progressively increase between adjacent ones of the passageways.
